(19) United States
(12) Patent Application Publication
(10) Pub. No.: US 2025/0049251 A1
(43) Pub. Date: Feb. 13, 2025

(54) FOOD PREPARATION DEVICE

(71) Applicants: Yonit SHAHAR MANTIN, Ganei Tikva (IL); Daniel MANTIN, Ganei Tikva (IL)

(72) Inventors: Yonit SHAHAR MANTIN, Ganei Tikva (IL); Daniel MANTIN, Ganei Tikva (IL)

(21) Appl. No.: 18/719,262

(22) PCT Filed: Dec. 4, 2022
(86) PCT No.: PCT/IB2022/061750

§ 371 Date: Jun. 13, 2024

(30) Foreign Application Priority Data
Dec. 13, 2021 (GB) 2117981.7

(51) Int. Cl. A47J 31/46; A47J 31/40; A47J 31/56

(52) U.S. Cl. CPC A47J 31/461; A47J 31/404; A47J 31/465; A47J 31/468; A47J 31/56; A47J 2202/00

(57) ABSTRACT

Provided is a food preparation device, such as a device for preparing baby formula, comprising a first reservoir for receiving and boiling water, in which the water is allowed to cool subsequent to boiling; a second reservoir for receiving and holding the cooled water from the first reservoir: a heating compartment for reheating a measured amount of the cooled water; a container for receiving dry powder formula; an outlet for dispensing the reheated measured amount of water; and a separate outlet for dispensing the dry powder formula.

### FIELD AND BACKGROUND OF THE INVENTION

The invention, in some embodiments, relates to the field of food preparation, and more particularly to a device for the preparation of a drinkable baby formula from a dry formula powder.

Preparation of a drinkable baby formula requires at least 4 separate steps, including boiling of water for sterilization, providing a measured amount of dry formula powder, providing a measured amount of the previously-boiled water for mixing with the formula powder at a suitable temperature and mixing the formula powder with the water to prepare the baby formula in a drinkable state.

Young babies require frequent feeding (generally 5-6 times in a 24 hour period), including during the night and/or in early morning. For young babies who are formula-fed, manual preparation of formula for drinking can be inconvenient and time-consuming for a carer, especially at hours which are outside the normal sleeping hours of the carer or when the carer is responsible for multiple babies. Furthermore, babies generally cry when hungry, at which point the carer will try to provide formula as quickly as possible. Delays during which water is first boiled to sterilize and then allowed to cool to a suitable temperature for drinking by the baby can be very stressful for both the baby and the carer. This is exacerbated by the fact that the hands of the carer are occupied during at least part of the preparation period such that he or she is unable to hold and comfort the crying baby.

Automated devices have been developed to carry out at least some of the necessary steps for preparation of drinkable baby formula. Many of these devices suffer from problems such as inaccurate dispensing of dry powder, resulting in a drinkable formula which may be too dilute and thus having an insufficient nutritional content; clogging of dispensing openings; and/or insufficient mixing of powder with water, resulting in formation of clumps of powder in the drinkable formula.

There is thus an unmet need for an automated baby formula preparation device which is devoid of at least some of the disadvantages of the prior art.

Background art includes U.S. Pat. Nos. 7,104,184: 8,007,847; US Publication No. 2006/150821; U.S. Pat. No. 5,570,816; US Publication No. 2010/112180; and US Publication No. 2021/007541.

### SUMMARY OF THE INVENTION

The present invention relates to a food preparation device, such as a device for preparing drinkable baby formula, comprising a first reservoir for receiving and boiling water, in which the water is allowed to cool subsequent to boiling; a second reservoir for receiving and holding the cooled water from the first reservoir; a heating compartment for reheating a measured amount of the cooled water; a container for receiving dry powder formula; an outlet for dispensing the reheated measured amount of water; and a separate outlet for dispensing the dry powder formula.

It is known in the art that certain minerals such as calcium carbonate are precipitated from water at boiling temperature and the presence of such precipitates in water used for preparation of drinkable baby formula is undesirable. On the other hand, boiling is generally a preferred method of sterilization of water for preparation of drinkable baby formula. The device of the present invention comprises a first reservoir in which water is first boiled and then allowed to cool to a temperature below boiling before being transferred to a second reservoir. This results in precipitated minerals being retained in the first reservoir such that water transferred to the second reservoir is essentially free of such precipitates.

It is further known in the art that dry milk powder, including dry powder formula, is highly hygroscopic such that contact with moisture results in clumping. Many known devices for preparation of drinkable baby formula use a single outlet for dispensing of both water and dry powder formula, such that any powder formula remaining on the outlet quickly forms clumps, resulting in blockage of the outlet. The present invention uses separate outlets for dispensing water and dispensing powder such that contact between water and dry powder prior to mixing is minimized.

Aspects and embodiments of the invention are described in the specification herein below and in the appended claims.

Unless otherwise defined, all technical and scientific terms used herein have the same meaning as commonly understood by one of ordinary skill in the art to which the invention pertains. In case of conflict, the specification, including definitions, will take precedence.

As used herein, the terms “comprising”, “including”, “having” and grammatical variants thereof are to be taken as specifying the stated features, integers, steps or components but do not preclude the addition of one or more additional features, integers, steps, components or groups thereof. These terms encompass the terms “consisting of” and “consisting essentially of”.

As used herein, the indefinite articles “a” and “an” mean “at least one” or “one or more” unless the context clearly dictates otherwise.

As used herein, when a numerical value is preceded by the term “about”, the term “about” is intended to indicate +/−10%.

According to an aspect of the present invention, there is provided a device for preparing a drinkable baby formula, the device comprising:
(a) a first reservoir configured to contain water, the first reservoir comprising
   (i) a first water inlet,
   (ii) a first heater configured to heat water contained in the first reservoir to boiling,
   (iii) a first sensor configured to determine a temperature of water contained in the first reservoir, and
   (iv) a first water outlet;
(b) a second reservoir configured to contain water, the second reservoir comprising
   (i) a water level sensor configured to determine a level of water in the second reservoir:
   (ii) a second water inlet functionally associated with a first controllable mechanism for controlling fluid communication between the first water outlet and the second water inlet, for transferring water at a preselected temperature lower than boiling from the first reservoir to the second reservoir when a level of water in the second reservoir is below a minimum level, and
   (iii) a second water outlet;
(c) a heating compartment configured to contain water, the heating compartment comprising
   (i) a third water inlet functionally associated with a second controllable mechanism for controlling fluid communication between the third water inlet and the second water outlet, for transferring a selected amount of water from the second reservoir to the heating compartment,
   (ii) a second heater configured to heat the predetermined amount of water contained in the heating compartment to a specific temperature range (in preferred embodiments, a user-selectable temperature range);
   (iii) a second sensor configured to determine a temperature of water contained in the heating compartment, and
   (iv) a third water outlet functionally associated with a third controllable mechanism for dispensing the selected amount of water at a temperature within the specific temperature range; and
(d) a dry powder formula container for storing dry formula powder, the container comprising a dry formula powder formula dispenser associated with a fourth controllable mechanism for dispensing a selected amount of dry powder formula from the container out through a dry powder formula outlet; and
(e) a controller configured to
   (i) activate the first heater with reference to a water temperature determined by the first sensor, in order to boil water contained in the first reservoir and to maintain the water at a boiling temperature for a preselected duration,
   (ii) activate the first controllable mechanism to transfer water at a cooled water temperature from the first reservoir to the second reservoir through the first water outlet and the second water inlet,
   (iii) activate the second controllable mechanism to transfer water from the second reservoir to the heating compartment reservoir through the second water outlet and the third water inlet,
   (iv) activate the second heater with reference to a water temperature determined by the second sensor in order to heat water in the heating compartment to about a preselected second temperature,
   (v) activate the fourth controllable mechanism for dispensing a selected amount of dry powder formula from the container out through a dry powder formula outlet, and
   (vi) activate the third controllable mechanism to dispense water from the heating compartment reservoir through the third water outlet.

In some embodiments, the controller is configured to receive from a user a preselection of at least one member of the group consisting of:
a said first temperature of water that is transferred from the first reservoir to the second reservoir
a said amount of water to be transferred from the second reservoir to the heating compartment
a temperature to heat the predetermined amount of water contained in the heating compartment
an amount of dry powder formula to be dispensed from said dry formula powder dispenser.

According to some embodiments, the dry powder outlet comprises a spout i.e. a tube or lip protruding from the dry formula powder container through which dry formula powder passes to be dispensed.

According to some embodiments, the device further comprises a vibration component for vibrating the dry formula powder outlet during dispensing of a selected amount of dry formula powder, the vibrating reducing the amount of dry formula powder sticking to the device.

According to some embodiments, the third water outlet comprises a spray nozzle through which water is dispensed so water is dispensed from the heating compartment as a spray. According to some such embodiments, the spray nozzle is controllable to dispense water at a selected pressure.

According to some embodiments, at least one of the first controllable mechanism, the second controllable mechanism and the third controllable mechanism is selected from the group consisting of a valve and a pump.

According to some embodiments, the first water inlet comprises a controllable one-way mechanism configured to allow exit of steam from the second water reservoir.

According to some embodiments, the first water inlet is configured for connection to a continuous water source or water dispenser, such as a tap, a home or office water dispenser device or the like.

According to some embodiments, the device further comprises:
(i) a third sensor configured to detect a water level in the first reservoir, and
(ii) a fifth controllable mechanism (in some embodiments comprising a valve and/or a pump) functionally associated with the first water inlet for controlling fluid communication between the continuous water source and the first water reservoir through the first water inlet when connected to the water source,
wherein the controller is further configured to activate the fifth controllable mechanism when a detected water level in the first reservoir is below a minimum level, to cause water from the water source to enter the first reservoir through the first water inlet.

According to some embodiments, the first reservoir comprises a conduit such as a pipe configured for connection to a continuous water source.

According to some embodiments, the device further comprises a bottle-receiving station, configured such that an upper open end of a bottle positioned therein receives the selected amount of dry powder formula dispensed from the dry formula powder outlet and the predetermined amount of water at a preselected temperature dispensed from the third water outlet.

According to some embodiments, the bottle-receiving station further comprises a weighing component for determining the weight of a bottle and contents thereof positioned therein.

According to some embodiments, the heating compartment is external to the second reservoir.

According to some embodiments, the heating compartment is situated within the second reservoir.

According to some embodiments, the heating compartment comprises a conduit such as a pipe.

According to some embodiments, the first water outlet and/or the second water inlet comprises a filter, in some embodiments of pore size from about 0.5 to about 10 microns, such as around 1 micron. Such a filter is configured for preventing the passage of particles such as sediment from the first water reservoir to the second water reservoir.

According to some embodiments, a dispensing end of the dry powder formula outlet comprises a cover. According to some such embodiments, the device further comprises a mechanism configured to move the cover to open the outlet for dispensing of dry powder formula and/or to move the cover to close the outlet following dispensing of dry formula powder.

In some such embodiments, the controller is further configured to control activation of the cover-moving mechanism.

According to some embodiments, the second heater is configured to heat the predetermined amount of water contained in the heating compartment to about a preselected temperature on demand on receipt of a user command input through the controller.

### BRIEF DESCRIPTION OF THE FIGURES

Some embodiments of the invention are described herein with reference to the accompanying figures. The description, together with the figures, makes apparent to a person having ordinary skill in the art how some embodiments of the invention may be practiced. The figures are for the purpose of illustrative discussion and no attempt is made to show structural details of an embodiment in more detail than is necessary for a fundamental understanding of the invention. For the sake of clarity, some objects depicted in the figures are not to scale.

In the Figures:

FIG. 1 schematically illustrates a device for preparing baby formula in accordance with the principles of the present invention;

FIG. 2 schematically illustrates an embodiment of the device of FIG. 1;

FIG. 3 schematically illustrates a further embodiment of the device of FIG. 1;

FIG. 4 schematically illustrates a further embodiment of the device of FIG. 1;

FIGS. 5A and 5B schematically illustrate embodiments of the dry powder formula container of FIG. 1; and

FIG. 6 schematically illustrates a further embodiment of the device of FIG. 1.

### DESCRIPTION OF SOME EMBODIMENTS OF THE INVENTION

Some embodiments of the invention relate to a food preparation device, such as a device for preparing drinkable baby formula, comprising a first reservoir for receiving and boiling water, in which the water is allowed to cool subsequent to boiling; a second reservoir for receiving and holding the cooled water from the first reservoir; a heating compartment for reheating a measured amount of the cooled water; a container for receiving dry formula powder; an outlet for dispensing the reheated measured amount of water; and a separate outlet for dispensing the dry formula powder.

Before explaining at least one embodiment in detail, it is to be understood that the invention is not necessarily limited in its application to the details of construction and the arrangement of the components and/or methods set forth herein. The invention is capable of other embodiments or of being practiced or carried out in various ways. The phraseology and terminology employed herein are for descriptive purpose and should not be regarded as limiting.

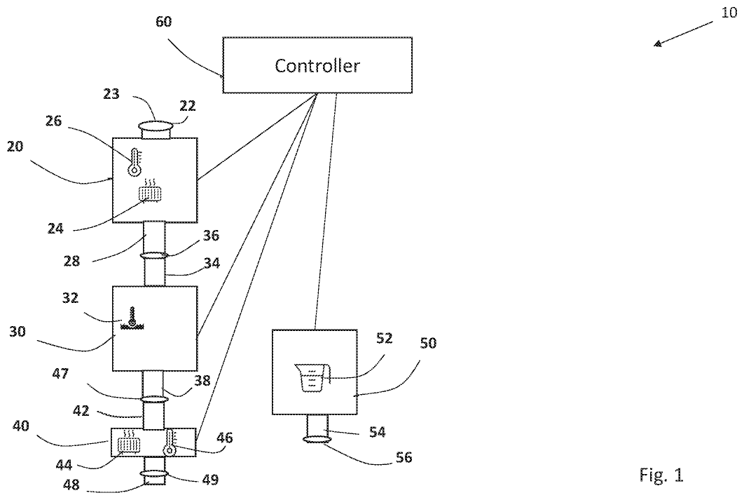

Referring now to FIG. 1, there is schematically depicted an embodiment of a device 10 for preparing drinkable baby formula in accordance with the principles of the present invention.

Device 10 comprises a first reservoir 20 configured to contain water; a second reservoir 30 configured to contain water; a heating compartment 40 configured to contain water; a dry formula powder container 50; and a controller 60 (a computer controller comprising hardware such as a processor, memory and peripherals and software for performing the required operations as known in the art of controllers for home-appliances).

### First Reservoir

First reservoir 20 comprises a first water inlet 22; a first heater 24 configured to heat water contained in first reservoir 20 to boiling point; a first temperature sensor 26 configured to determine a temperature of water contained in first reservoir 20; and a first water outlet 28.

First reservoir 20 is removable from device 10 and is made of any suitable material which is compatible for contact with liquids intended for human consumption at temperatures of up to 100° C., e.g. must be non-toxic and non-degradable at temperatures of up to 100° C. for a required time period. Preferably, the material is such that first reservoir 20 is dishwasher-safe. Non-limiting examples of suitable materials include, for example plastics, metals and glass as known in the art of coffee makers and such home appliances. In some embodiments, at least some of the walls of the first reservoir are insulated or are configured to have relatively low heat conduction: such configuration reduces the amount of energy required to boil the water therein and also reduces the chance that a person's contact with the wall can cause discomfort.

First reservoir 20 preferably has a volume in the range of about 0.8-2 liters, more preferably about 900-1.5 liters.

For use, reservoir 20 is at least partially filled with water via first water inlet 22. The water may comprise, for example, tap water, distilled water, filtered water, bottled water, or water from a home or office water dispenser and may be provided at any temperature.

According to some embodiments, water inlet 22 comprises a controllable one-directional closure, such as a valve 23, which may be controlled manually when water input is required or may be controlled automatically by controller 60 when a drinkable formula preparation cycle is activated by the user. One-directional controllable closure 23 is configured to allow release of steam from reservoir 20, while preventing entry of air and/or dirt to reservoir 20. Reservoir 20 may be filled manually to a desired level.

According to some embodiments, first water inlet 22 and/or first water outlet 28 is provided with a filter to remove particles such as sediment that are formed by the boiling of water in the first reservoir, preferably of pore size from about 0.5 to about 10 microns, such as about 0.5, about 1, about 2, about 3, about 4, about 5, about 6, about 7, about 8, about 9 or about 10 microns.

### Second Reservoir

Second reservoir 30 comprises a water level sensor 32 configured to determine a level of water in second reservoir 30; a second water inlet 34 and a second water outlet 38. Second water inlet 34 is functionally associated with a first controllable mechanism 36 for controlling fluid communication between first water outlet 28 and second water inlet 34, for transferring water at a predetermined temperature lower than boiling from first water reservoir 20 to second reservoir 30 when a water level in second reservoir 30 is identified by water level sensor 32 as being lower than a predefined level and a water temperature in first reservoir 20 is determined by first temperature sensor 26 as being lower than a preselected temperature. In some embodiments, first controllable mechanism 36 comprises a valve and/or a pump.

Second reservoir 30 is made of any suitable material which is compatible for contact with liquids intended for human consumption e.g. must be non-toxic and non-degradable at room temperature for a required time period. Preferably, the material is such that second reservoir 30 is dishwasher-safe. Non-limiting examples of suitable materials include, for example plastics, metals and glass as known in the art of coffee makers and such home appliances. In some embodiments, at least some of the walls of the first reservoir are insulated or are configured to have relatively low heat conduction: such configuration reduces the amount of energy required to boil the water therein and also reduces the chance that a person's contact with the wall can cause discomfort.

Second reservoir 30 preferably has a volume in the range of about 0.8-2 liters, more preferably about 0.9-1.5 liters. According to a preferred embodiment, a volume of second reservoir 30 is about the same as that of first reservoir 20, such that substantially all of the cooled water from first reservoir 20 can be transferred to second reservoir 30, enabling reservoir 20 to be substantially emptied and refilled with fresh water.

According to some embodiments, second water inlet 34 and/or second water outlet 38 is provided with a filter to remove particles such as sediment that are present in second reservoir 30, preferably of pore size from about 0.5 to about 10 microns, such as about 0.5, about 1, about 2, about 3, about 4, about 5, about 6, about 7, about 8, about 9 or about 10 microns.

### Heating Compartment

Heating compartment 40 comprises a third water inlet 42; a second water heater 44; a second temperature sensor 46; and a third water outlet 48.

Third water inlet 42 is functionally associated with a second controllable mechanism 47 for controlling fluid communication between third water inlet 42 and second water outlet 38, for transferring a predetermined amount of water from second reservoir 30 to heating compartment 40; and with a third controllable mechanism 49 for controlling dispensing of water through third water outlet 48. In some embodiments, one or both of second controllable mechanism 47 and third controllable mechanism 49 comprises a valve (e.g., a ball valve functionally associated with an electrical motor under control of controller 60 to open and close the valve) and/or a pump (e.g., a peristaltic pump under control of controller 60 to activate and deactivate the pump).

According to some embodiments, third water outlet 48 comprises a spray nozzle, optionally controllable to dispense water as a spray at a selected pressure. Dispensing water at a selected pressure as a spray into a vessel such as a bottle like a baby bottle into which dry formula powder has previously been dispensed assists in mixing of the formula powder with the spray-dispensed water.

Heating compartment 40 preferably has a smaller volume than water reservoir 20 such that a relatively small, predetermined amount of water can be withdrawn for rapid heating. Second water heater 44 is configured to heat the predetermined amount of water contained in heating compartment 40 to a preselected temperature.

The predetermined amount of water is optionally a volume of water required to prepare a single feed for a baby. The volume of water required will depend at least partially on the age and weight of the baby, but will generally be in the range of from 30 ml to 240 ml. According to some preferred embodiments, the preselected temperature is a temperature recommended by the manufacturer of the dry formula powder to be used, such that the dry formula powder will be fully dissolved in the water without clumping, The preselected temperature is any temperature at which a baby would comfortably drink a prepared formula, such as from room temperature to about 38° C., more preferably a temperature at or below normal body temperature, such as from about 36 to about 37.5° C., to emulate a temperature of breast milk.

According to embodiments wherein the preselected temperature is room temperature, second water heater 44 is not activated.

Second temperature sensor 46 is configured to determine a temperature of water contained in heating compartment 30 and to report the determined temperature to controller 60.

Heating compartment 40 is made of any suitable material which is compatible for contact with liquids intended for human consumption e.g. must be non-toxic and non-degradable at a temperature between room temperature and at least about 40° C. for a required time period. Non-limiting examples of suitable materials include, for example plastics, metals and glass, as known in the art of coffee makers and such home appliances.

According to some embodiments, during use, water is boiled and subsequently allowed to cool in first reservoir 20; cooled water from first reservoir 20 is transferred to second reservoir 30; and at least a portion of cooled water from second reservoir 30 is transferred to heating compartment 40.

### Dry Powder Formula Container

Dry powder formula container 50 comprises a measuring component 52 for measuring a selected amount of dry formula powder and a dry formula powder outlet 54 functionally associated with a fourth controllable mechanism 56 for dispensing the selected amount of dry formula. In some embodiments, measuring component 52 is a component of fourth controllable mechanism 56. Alternatively, in some embodiments, measuring component 52 is a component separate from fourth controllable mechanism 56.

According to some embodiments, dry powder formula outlet 54 comprises a protruding lip or spout. According to some such embodiments, dry formula powder outlet 54 is arranged at an angle of from about 30° to about 55°, such as about 45° to the vertical axis of the device when the device is on a flat surface for use.

According to some embodiments (not shown), device 10 may be provided with at least two dry powder containers 50a and 50b, wherein dry powder container 50a may be filled with a different formula composition from that of dry powder container 50b, such that device 10 may be used for preparing feeds for multiple infants having different feed requirements by inserting a dry powder container containing the appropriate composition in device 10. Different formula compositions may include, for example, hypoallergenic or lactose-free compositions, compositions for premature babies or for different ages. Alternatively, device 10 may comprise at least two sub-compartments 50c, 50d within a dry powder container 50, wherein controller 60 is configured to dispense from an appropriate sub-container as selected by a user. According to some such embodiments, each container or sub-compartment may be provided with an electronic identifier, such as a barcode which is associated with a corresponding identifier on a receiving vessel such as a bottle belonging to a specific infant, such that controller 60 is configured to dispense dry powder formula from a specific compartment or container only into a specific bottle. By this means, device 10 may be used for multiple babies or infants having different feeding requirements, without the risk of accidentally mixing the bottles.

### Controller

Controller 60 is configured to perform the following operations:

(i) Activate first water heater 24 in accordance with a first water temperature in first reservoir 20, as determined by first sensor 26. When the detected first water temperature in first reservoir 20 is less than 100° C., first water heater 24 is activated until a detected water temperature of 100° C. is attained. First heater 24 maintains the water temperature at 100° C. for a predetermined duration which is sufficient to sterilize the water.

Preferably, the predetermined duration is from about 1 minute to about 2 minutes but may vary according to the source of water used at a specific location.

At the end of this predetermined duration, controller 60 deactivates first water heater 24 such that water contained in first reservoir 20 is allowed to cool from boiling.

(ii) Activate first controllable mechanism 36 in accordance with a cooled water temperature detected by first temperature sensor 26 in first reservoir 20 and a predefined water level detected by water level sensor 32 in second reservoir 30. Activation of first controllable mechanism 36 allows water to pass from first reservoir 20 to second reservoir 30 through first water outlet 28 and second water inlet 34.

The cooled water temperature may be any temperature below boiling point, but preferably below about 80° C., such as below 80° C., below about 70° C., below about 60° C., below about 50° C., below about 40° C. or even below about 30° C. According to some embodiments, the cooled water temperature is room temperature. The cooled water temperature may optionally be a predetermined temperature detected by a fourth temperature sensor 33. Alternatively, the cooled water temperature may be a temperature reached after allowing the previously boiled water in reservoir 20 to cool for a given time, such as at least 5 minutes, at least 10 minutes, at least 20 minutes, or even at least 30 minutes.

According to some embodiments, a predefined water level is optionally less than 1 cm, less than 0.5 cm, less than 1 mm, or even less than 0.5 mm.

When the predetermined cooled water temperature in first reservoir 20 is reached, or when the water has been allowed to cool for the given time, and a water level below the predefined water level is reached, first controllable mechanism 36 is activated to allow water to pass from reservoir 20 to reservoir 30. When substantially all the water from reservoir 20 has passed to reservoir 30, first controllable mechanism 36 is deactivated to prevent fluid communication via first water outlet 28 and second water inlet 34 such that any water subsequently added to first reservoir 20 cannot pass directly to second reservoir 30.

(iii) Activate second controllable mechanism 47. Activation of second controllable mechanism 47 allows a preselected amount of water to pass from second reservoir 30 to heating compartment 40 through second water outlet 38 and third water inlet 42. Second controllable mechanism 47 may optionally be activated on demand when it is desired to transfer water from second reservoir 30 to heating compartment 40 or may be activated at preselected times. Once a preselected amount of water has passed from second reservoir 30 to heating compartment 40, controllable mechanism 47 is deactivated to prevent further transfer of water until required.

(iv) Activate second water heater 44 with reference to a water temperature determined by second temperature sensor 46. Activation of second water heater 44 heats water in heating compartment 40 to about a preselected temperature. Second water heater 44 may be activated on demand when heating of water in heating compartment 40 is desired. Alternatively, second water heater 44 may be activated automatically following transfer of water from second reservoir 30 to heating compartment 40. Once water in heating compartment 40 has reached the preselected temperature, second water heater 44 is deactivated.

(v) Activate fourth controllable mechanism 56 to open dry powder formula outlet 54 to dispense a preselected amount of dry powder formula and subsequently close to prevent further dispensing.

(vi) Activate and deactivate a third controllable mechanism 49. Activation of third controllable mechanism 49 enables water to be dispensed from heating compartment 40 through third water outlet 48. Once substantially all the water from heating compartment 40 has been dispensed, third controllable mechanism 49 is deactivated. Activation of third controllable mechanism 40 preferably occurs subsequent to activation of fourth controllable mechanism 56, such that dry powder is dispensed prior to dispensing of water.

In some embodiments, the controller is functionally associated with an output display and is configured to display information about the device operation to a user. Such a display is any suitable display such as an LCD or LED screen or touchscreen as known in the art of home appliances.

In some embodiments, the controller is functionally associated with a user interface that allows a user to input commands and preferences. Such a user interface is any suitable interface such as one or more of a keyboard, touch screen or control buttons as known in the art of home appliances. Additionally or alternatively, in some embodiments the user interface is wirelessly accessible by a user (e.g., Wifi, Bluetooth) (e.g., using an appropriate application running on a user smartphone). In some such embodiments, the controller is configured to receive from a user at least one member of the group consisting of:
a said first temperature of water that is transferred from the first reservoir to the second reservoir
a said amount of water to be transferred from the second reservoir to the heating compartment
a temperature to heat the predetermined amount of water contained in the heating compartment
an amount of dry powder formula to be dispensed from said dry formula powder dispenser.

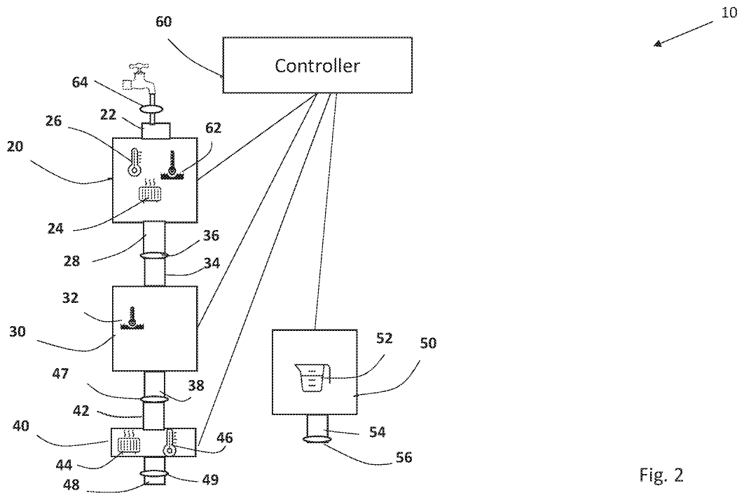

According to some embodiments, first water inlet 22 is configured for direct connection to a water source, such as a tap. According to some such embodiments, as shown in FIG. 2, device 10 further comprises a water level sensor 62 configured to detect a water level in first reservoir 20 and a fifth controllable mechanism 64, such as a valve or pump, functionally associated with first water inlet 22 for controlling fluid communication between the water source and first water inlet 22 when connected to the water source.

According to some such embodiments, first reservoir 20 comprises a conduit such as a pipe configured for connection to the water source.

According to some such embodiments, controller 60 is further configured to activate fifth controllable mechanism 64 when a detected water level in first reservoir 20 is below a preselected minimum level, to open first water inlet 22 wherein water passes from the water source into first reservoir 20 and to deactivate fifth controllable mechanism 64 when a desired water level is reached in reservoir 20, such that fluid connection is closed between the water source and first water inlet 22.

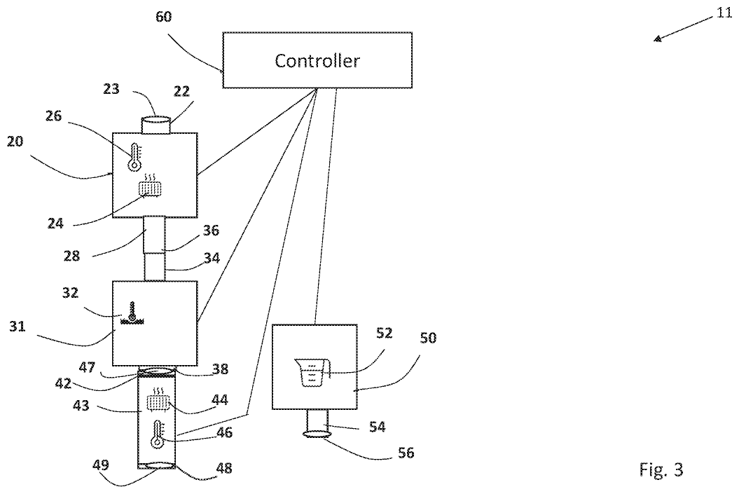

According to some embodiments of device 10 of the present invention, as shown in FIGS. 1 to 3, heating compartment 40 is external to second reservoir 30. In some such embodiments 11, heating compartment 40 comprises a conduit, such as a pipe 43, extending from a second reservoir 31, as show in in FIG. 3.

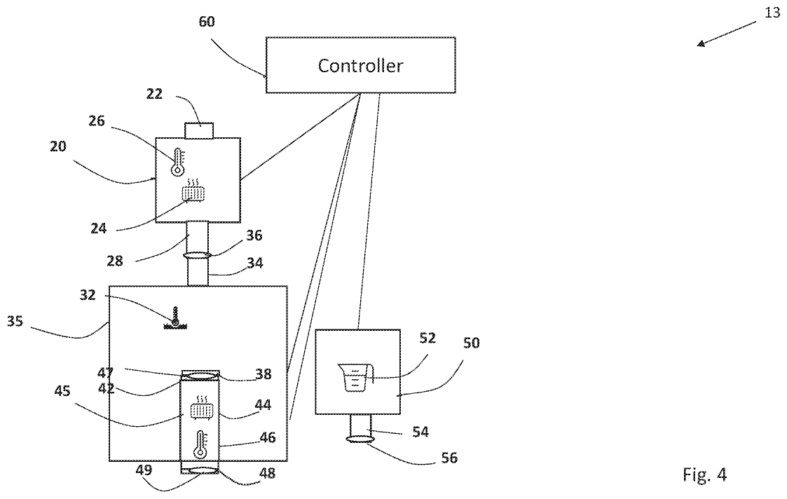

According to some alternative embodiments 13, as shown in FIG. 4, there is provided a heating compartment 45 which is a sub-compartment or chamber situated within a second reservoir 35. According to some such embodiments, heating compartment 45 comprises a conduit, such as a pipe situated within second reservoir 30. According to some such embodiments, the pipe may optionally be a substantially straight pipe, a coiled pipe or a corrugated pipe. In some such embodiments, the heating compartment has heat-conducting walls. In some such embodiments, the heating compartment has heat-insulating walls.

According to some embodiments, third water inlet 42 and/or third water outlet 48 is provided with a filter to remove particles, preferably of pore size from about 0.5 to about 10 microns, such as around 1 micron.

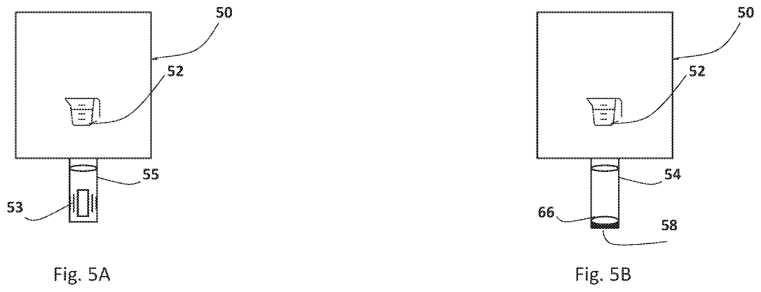

According to some embodiments, as shown in FIG. 5A, a vibration component 53 is associated with a dry powder formula outlet 55, such that dry formula powder outlet 55 is vibrated during dispensing of dry formula powder. Such vibration assists in preventing dry powder from sticking to dry formula powder outlet 55 and ensures that the entire selected amount of dry formula powder is dispensed.

Measuring component 52 may comprise, for example, a screw pump dispenser.

A selected amount of dry formula powder is an amount of dry formula power to be added to an appropriate volume of water from the heating compartment in order to provide a drinkable baby formula of a suitable concentration. The exact ratio of powder to water may depend on the specific dry formula powder used, as specified in the formula powder manufacturer's instructions. In general, 8-9 g of dry formula powder are dissolved in every 60 ml water to provide drinkable baby formula, according to manufacturer's instructions.

According to some embodiments, as shown in FIG. 5B, dry formula powder outlet 54 (or 55) is provided with a removable cover 58, which serves to keep the dry powder formula contained within dry powder formula container 50 clean and dry. For example, cover 58 protects the dry powder formula in dry powder formula container 50 and/or in dry powder formula outlet 54 from exposure to dust, as well as from exposure to steam or moisture which may be present in the environment or produced during dispensing of water from third water outlet 48. According to some such embodiments, device 10 further comprises a controllable mechanism 66 configured to move cover 58 to open dry powder formula outlet 52 for dispensing of dry powder formula and/or to move cover 58 to close dry powder formula outlet 52 following dispensing of the dry formula powder. Preferably the sixth controllable mechanism is controlled by the controller.

According to some such embodiments, controller 60 is further configured to activate sixth controllable mechanism 66 to move cover 58 to open dry powder formula outlet 52 for dispensing of dry powder formula and/or to move cover 58 to close dry powder formula outlet 52 following dispensing of the dry powder formula.

### Bottle-Receiving Station

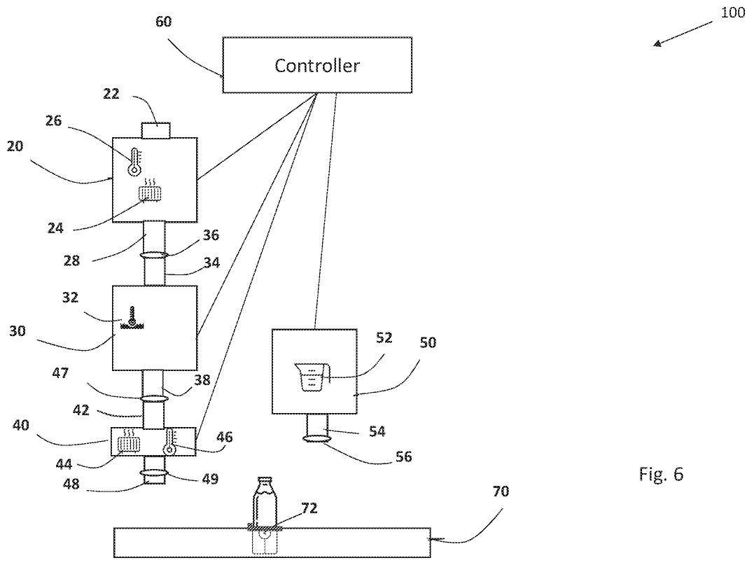

According to some embodiments, as shown in FIG. 6, there is provided a device 100 further comprising a bottle-receiving station 70, such as a platform extending perpendicularly from a casing of device 100, configured such that an upper open end of a bottle positioned therein receives the selected amount of dry powder formula dispensed from dry powder formula outlet 54 and the predetermined amount of water at a preselected temperature dispensed from third water outlet 48.

According to some embodiments, device 100 further comprises a weighing component 72, optionally located on or within weighing station 70, for determining the weight of a bottle positioned therein, including the contents thereof. Weighing component 72 may be used to weigh a bottle containing prepared drinkable formula in order to ascertain that the correct amount of water and dry powder have been dispensed and/or to weigh a bottle after a baby has finished drinking the prepared formula in order to ascertain an amount of drinkable formula consumed.

### Use of the Device

Prior to use, device 10 may be pre-programmed to select a number of preferred variables, such as a desired volume of drinkable formula to be prepared and dispensed, a desired temperature at which the prepared formula is provided. Such parameters may be selected prior to each use, or may be stored in a memory of controller 60 as individual profiles, such as for use in preparing formula for multiple babies., e.g., via a user interface.

Following selection of the desired parameters or profile, device 100 is activated to automatically and sequentially perform each of the functions described herein, in order to produce a ready to drink formula.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and scope of the appended claims.

Citation or identification of any reference in this application shall not be construed as an admission that such reference is available as prior art to the invention.

1. A device for preparing a baby formula, the device comprising:
(a) a first reservoir configured to contain water, said first reservoir comprising
(i) a first water inlet,
(ii) a first heater configured to heat water contained in said first reservoir to boiling,
(iii) a first sensor configured to determine a temperature of said water contained in said first reservoir, and
(iv) a first water outlet;
(b) a second reservoir configured to contain water, said second reservoir comprising
(i) a water level sensor configured to determine a level of water in said second reservoir;
(ii) a second water inlet functionally associated with a first controllable mechanism for controlling fluid communication between said first water outlet and said second water inlet, for transferring water at a preselected temperature lower than boiling from said first reservoir to said second reservoir when said level of water in said reservoir is below a minimum level, and
(iii) a second water outlet;
(c) a heating compartment configured to contain water, said heating compartment comprising
(i) a third water inlet functionally associated with a second controllable mechanism for controlling fluid communication between said third water inlet and said second water outlet, for transferring a selected amount of water from said second reservoir to said heating compartment,
(ii) a second heater configured to heat said predetermined amount of water contained in said heating compartment to a specific temperature range;
(iii) a second sensor configured to determine a temperature of said water contained in said heating compartment, and
(iv) a third water outlet functionally associated with a third controllable mechanism for dispensing said predetermined amount of water at a temperature within the specific temperature range; and
(d) a dry powder formula container for storing a dry powder formula, said container comprising a dry powder formula dispenser associated with a fourth controllable mechanism for dispensing a selected amount of dry powder formula from the container out through a dry powder formula outlet; and
(e) a controller configured to
(i) activate said first heater with reference to a water temperature determined by said first sensor, in order to boil water contained in said first reservoir and to maintain said water at a boiling temperature for a preselected duration,
(ii) activate said first controllable mechanism to transfer water at a cooled water temperature from said first reservoir to said second reservoir through said first water outlet and said second water inlet,
(iii) activate said second controllable mechanism to transfer water from said second reservoir to said heating compartment reservoir through said second water outlet and said third water inlet,
(iv) activate said second heater with reference to a water temperature determined by said second sensor in order to heat water in said heating compartment to about said preselected temperature,
(v) activate the fourth controllable mechanism for dispensing a selected amount of dry powder formula from said container out through said dry powder formula outlet, and
(vi) activate said third controllable mechanism to dispense water from said heating compartment reservoir through said third water outlet.

2. The device of claim 1, wherein said dry powder outlet comprises a spout.

3. The device of claim 1, further comprising a vibration component for vibrating said dry powder formula outlet during said dispensing of said selected amount of dry powder formula.

4. The device of claim 1, wherein said third water outlet comprises a spray nozzle.

5. The device of claim 4, wherein said spray nozzle is controllable to dispense water at a selected pressure.

6. The device of claim 1, wherein at least one of said first controllable mechanism, said second controllable mechanism and said third controllable mechanism is selected from the group consisting of a valve and a pump.

7. The device of claim 1, wherein said first water inlet comprises a controllable one-way mechanism configured to allow exit of steam from said first water reservoir.

8. The device of claim 1, wherein said first water inlet is configured for connection to a continuous water source.

9. The device of claim 8, further comprising
(i) a third sensor configured to detect a water level in said first reservoir, and
(ii) a fifth controllable mechanism functionally associated with said first water inlet for controlling fluid communication between said water source and said first water inlet when connected to said water source,
wherein said controller is further configured to activate said fifth controllable mechanism when said detected water level in said first reservoir is below a minimum level, to open said first water inlet wherein water passes from said water source to said first reservoir.

10. The device of claim 8, wherein said first reservoir comprises a conduit configured for connection to said continuous water source.

11. The device of claim 1, further comprising a bottle-receiving station, configured such that an upper open end of a bottle positioned therein receives said selected amount of dry powder formula dispensed from said dry powder formula outlet and said predetermined amount of water at said preselected temperature dispensed from said third water outlet.

12. The device of claim 11, wherein said bottle-receiving station further comprises a weighing component for determining the weight of a bottle positioned therein.

13. The device of claim 1, wherein said heating compartment is external to said second reservoir.

14. The device of claim 1, wherein said heating compartment is situated within said second reservoir.

15. The device of 13, wherein said heating compartment comprises a conduit.

16. The device of claim 1, wherein any one or more selected from the group consisting of said first water outlet, said second water inlet, said third water inlet, said first water outlet, said second water outlet and said third water outlet comprises a filter.

17. The device of claim 1, wherein a dispensing end of said dry powder formula outlet comprises a cover and a mechanism configured to move said cover for dispensing of said dry powder formula.

18. The device of claim 1, wherein said dry powder formula outlet is arranged at an angle of from about 30° to about 55° to a vertical axis of the device when the device is on a flat surface for use.

19. The device of claim 1, wherein said second heater is configured to heat said predetermined amount of water contained in said heating compartment to about said preselected temperature on demand.
